(19) United States
(12) Patent Application Publication
(10) Pub. No.: US 2003/0198813 A1
(43) Pub. Date: Oct. 23, 2003

(54) Polymeric membranes

(76) Inventor: George D. Howell, Arlington, TX (US)

Correspondence Address: Sanford E. Warren, Jr., GARDERE WYNNE SEWELL LLP, 3000 Thanksgiving Tower, 1601 Elm Street, Dallas, TX, 75201, US

(21) Appl. No.: 10/127,780

(22) Filed: Apr. 22, 2002

(51) Int. Cl. B32B 9/04

(52) U.S. Cl. 428/411.1

(57) ABSTRACT

A roofing membrane is described. The roofing membrane contains at least one thermoplastic layer. The thermoplastic layer contains at least one thermoplastic material and at least one microbial inhibitor integrated into the thermoplastic.

### TECHNICAL FIELD OF THE INVENTION

The present invention relates generally to roofing materials, and more particularly, to roofing membranes that inhibit the growth of microorganisms, are highly reflective and are energy efficient.

### BACKGROUND OF THE INVENTION

Without limiting the scope of the invention, its background is described in connection with roofing systems used in the construction industry.

Many different types of roofing systems are available in the construction industry and are used on a wide variety of structures. For example, asphalt-based or wood-based shingle systems have been a popular product in the U.S. residential roofing market. Metal roofing systems have also been used and are often seen on commercial structures. In addition, various single-ply roofing systems made from thermoset and thermoplastic materials are available and widely used.

One purpose of a roofing system is to provide energy efficiency for the underlying structure. It is known in the industry that a dark-colored roofing system is not as energy efficient as a light-colored roofing system, primarily because dark colors absorb heat more readily than light colors. Roofing systems that absorb radiant heat can result in high cooling costs for the underlying structure. Recognizing this, many commercial builders have employed lighter colored roofs in their structures so as to increase energy efficiency by reflecting radiant heat away from the structure. Thus, a roofing system's “reflectivity” or ability to reflect sunlight and radiant heat is an important aspect in measuring a roofing system's energy efficiency.

Over time, a roofing system may lose its reflectivity, which can result in a loss of energy efficiency for the underlying structure. Many factors contribute to a roofing system's loss of reflectivity. For example, roofing systems that become cracked or discolored due to adverse weather conditions may lose their reflectivity. In addition, the accumulation of dirt or debris can cause a roof to lose its reflectivity. Moreover, roofing systems that are exposed to damp conditions or humid climates may foster the growth of microorganisms, such as algae or fungi. The presence of microorganisms can cause discoloration in a roofing membrane, which causes the membrane to lose reflectivity.

To combat the growth of microorganisms on roofing systems, some manufacturers have applied various biocides directly to the roofing membrane. Typically, these roofing system biocides are a multi-layered granule composed of heavy metals such as arsenic, silver, and copper. These biocides are often costly to construct, and can be highly regulated due to their heavy metal content. In addition, the components often detract from the overall weatherability of the roofing material over time, resulting in poor reflectivity and energy efficiency.

### SUMMARY OF THE INVENTION

It is therefore desired to have a roofing membrane that is highly reflective and is able to maintain its reflectivity over a long period of time. It is also desired to have a roofing membrane that is able to inhibit the growth of microorganisms. It is further desired to have a roofing membrane that is able to inhibit the growth of microorganisms by using less expensive and less environmentally regulated components. It is also desired to have a roofing membrane that is constructed of components that aid in the weatherability of the roofing membrane.

In one embodiment of the present invention, a roofing membrane is described. The roofing membrane contains at least one thermoplastic layer. The thermoplastic layer contains at least one thermoplastic material and at least one microbial inhibitor integrated into the thermoplastic. The thermoplastic layer containing the microbial inhibitor may be laminated or coextruded onto another layer of material that may or may not contain an inhibitor.

In another embodiment of the present invention, a method of making a roofing membrane is described. The method includes contacting at least one thermoplastic layer and at least one scrim layer. Generally, at least a portion of the scrim layer is in contact with the thermoplastic layer. The thermoplastic layer contains at least one thermoplastic material and at least one microbial inhibitor.

In another embodiment of the present invention, a method of making a roofing membrane is described. The method includes contacting at least one thermoplastic layer and at least one scrim layer. Generally, at least a portion of the scrim layer is in contact with the thermoplastic layer. The thermoplastic layer contains thermoplastic olefinic elastomer and zinc oxide.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not limit the scope of the invention.

The present invention includes roofing membranes that are resistant to the growth of microorganisms, use components that are not highly regulated, and use components that enhance the weatherability of the roofing membrane. The roofing membrane may be constructed of any material suitable for roofing membranes, such as thermoplastic, thermoset, polymeric, or bituminous materials. Generally, the roofing membrane may be constructed of multi-layers of thermoplastic and may also include layers of scrim material. As used herein, the term “thermoplastic” may be defined as a material (such as vinyl) that can be formed, fused or changed using heat. Thermoplastics are well suited for use with roofing membranes since installation techniques such as heat sealing may be used. Additionally, microbial inhibitors may be introduced into the thermoplastic material and the layers combined using a calendaring apparatus to form a roofing membrane. The roofing membrane may then be applied to a roof in any manner known in the art.

Roofing membranes useful in the present invention may contain at least one layer, and may contain multiple layers of material. For example, membranes useful in the present invention may contain one or more thermoplastic layers and may also contain one or more scrim layers. Additionally, the thermoplastic layer may contain a microbial inhibitor. In one embodiment of the present invention, the roofing membrane may contain an upper layer of thermoplastic material, a lower layer of thermoplastic material, and a scrim layer located between the upper layer and lower layer of thermoplastic material. In another embodiment of the present invention, the roofing membrane may contain multiple layers of scrim material interspersed throughout one or more layers of thermoplastic material. In another embodiment of the present invention, the roofing membrane may contain a scrim layer and a thermoplastic layer on top of the scrim layer. In another embodiment of the present invention, the roofing membrane contains one or more layers of thermoplastic material and does not contain a scrim layer.

Generally, thermoplastic layers of the present invention contain at least one thermoplastic material. The thermoplastic layer may be a variety of materials such as thermoplastics, thermosets, and materials made of various polymers or other bituminous materials. The thermoplastic material may be any thermoplastic known in the art such as ABS, polycarbonate, Noryl™, PVC, styrene, ABS/PVC, PVC/Acrylic, polysulfone, and polyethylene. Additional examples of thermoplastic material include, but are not limited to, ethylene propylene diene monomer (EPDM)-based thermoset, polyvinyl chloride (PVC), and thermoplastic olefinic elastomer (TPO), such as polypropylene (for example, Soft Catalloy® available from Basell). TPO includes those compounds provided by the ASTM definition of TPO, and also EPDM rubber and other appropriate rubbers or polymers or mixtures thereof in combination with polypropylene, polyethylene, and polybutylene. Other suitable alpha-olefin and copolymers as well as mixtures of any of the above-referenced compounds are also suitable for use in the present invention.

The thermoplastic material may be used in conjunction with non-thermoplastic materials and may include mixtures of different thermoplastic and non-thermoplastic materials. Roofing membranes of the present invention may include one or more thermoplastic layers containing one or more thermoplastic materials. If multiple thermoplastic layers are used in a roofing membrane, the thermoplastic material may vary from layer to layer in concentration, amount, and type of thermoplastic material. The thermoplastic material of one thermoplastic layer may be the same or different thermoplastic material as another thermoplastic layer. For example, a roofing membrane may contain two layers, an upper and lower layer, of thermoplastic material. In one embodiment of the present invention, the upper layer and lower layer is TPO. In another embodiment of the present invention, the upper layer and lower layer is PVC.

Roofing membranes of the present invention generally contain at least one microbial inhibitor. The term “microbial inhibitor” is defined to be any substance that is capable of inhibiting and/or preventing the growth of microorganisms. Microbial inhibitors include algaecides, mildewcides, fungicides and the like and mixtures thereof. Microbial inhibitors of the present invention may kill or inhibit various microorganisms, examples of which include, but are not limited to, bacteria, algae and fungi. Generally, if the microorganism is an algae and/or fungi, it may generally be a type of algae and/or fungi commonly associated with causing discoloration of roofs and other surfaces. The amount and type of microbial inhibitor used in the present invention may vary depending on the type of microorganism desired to be resisted or killed. In addition, the amount and type of microbial inhibitor may vary depending on the climate, the temperature, the humidity, and other weather conditions that may cause the growth or lack of growth of microorganisms on roofing membranes.

Examples of microbial inhibitors useful in the present invention include compounds of metal oxides. Useful examples of metal oxides include, but are not limited to, zinc oxide. Other useful microbial inhibitors include zinc compounds, examples of which include, but are not limited to, zinc chloride and zinc stearate. Other useful examples include compounds containing copper, silver and arsenic. In one embodiment of the present invention, zinc oxide is used as a microbial inhibitor.

Microbial inhibitors of the present invention also may serve as an ultraviolet (UV) absorber and/or protectant. Zinc oxide may be useful as a UV stabilizer and/or protectant and may often be synergistic with other UV stabilizers, for example, Chimmasorb 944™ and Tinuvin 770™. Microbial inhibitors of the present invention generally may inhibit or prevent the growth of microorganisms and may also protect the roofing membrane from UV rays and other conditions that may cause the roofing membrane to weather over time.

Microbial inhibitors useful in the present invention generally are present in an amount effective to prevent or inhibit the growth of microorganisms such as algae and fungi. In one embodiment of the present invention, microbial inhibitors are present in an amount in the range of from greater than about 3 weight percent to about 90 weight percent, based on the weight percent of the thermoplastic. In another embodiment of the present invention, the microbial inhibitor is present in an amount in the range of from greater than about 3 weight percent to about 40 weight percent. In another embodiment of the present invention, the microbial inhibitor is present in an amount in the range of from about 5 weight percent to about 30 weight percent. In another embodiment of the present invention, the microbial inhibitor is present in an amount in the range of from about 7 weight percent to about 20 weight percent.

Although the present invention is directed towards roofing membranes, compositions described herein are not limited to such use. Formulations described herein may also be used on or in other materials that would benefit from inhibited or decreased growth of microorganisms such as algae and/or fungi. Examples of other uses include, but are not limited to, flooring materials, home siding materials, furnishings, vehicle construction, lawn equipment, farm equipment, shingles and various roofing materials. Other uses include plastic lumber, holding tanks, porta-potties, and the like.

Roofing membranes of the present invention may also contain other components such as anti-foam agents, antioxidants such as Westin 626™ (available from GE), coalescent aids, wetting aids, adhesion promoters, pigments and freeze-thaw stabilizers, as well as UV absorbers, protectants, and/or stabilizers. Useful UV stabilizers include, but are not limited to, Chimmasorb 944™ (available from Ciba) Tinuvin 770™ (available from Ciba) and others.

Various pigments may also be used in the present invention to provide appropriate color, if desired, to the roofing membrane. Pigments may be used at a low level where desired to maintain a semi-transparency. Pigments may also be used as fillers, to increase cohesive strength and stiffness, reduce surface tack, and reduce abrasion. Pigments may be combined to provide desirable characteristics in the final roofing membrane. Pigments may also be described as micas, graphite, talcs, aluminum hydrate, carbon black, lithopone, ferric/ferrous oxides, whiting, magnesium oxide, magnesium carbonate, and the like and mixtures thereof. Useful examples of pigments in the present invention include, but are not limited to, titanium dioxide.

Roofing membranes of the present invention also may contain at least one scrim layer made of scrim material. The scrim layer, or at least a portion of the scrim layer, may be in contact with the thermoplastic layer. The scrim layer may be made of various materials including, but not limited to, polyester, fiberglass, cotton, or other reinforcing materials familiar to those of skill in the art. For example, the scrim material may be any fibrous, oriented or un-oriented, material that imparts added strength to a roofing membrane. An individual component of a scrim layer may be referred to as a sheet. In some cases, a sheet is not continuous across the entire width of the membrane, but is made up of one or more pieces of scrim material.

Roofing membranes of the present invention generally have little loss of reflectivity. Unexposed roofing membranes generally reflect up to 85% of incident solar radiation. Reflectivity may be measured by various means known in the art, such as the commercially available portable solar spectrum reflectometer (SSR) (available from Devices and Services Co., Dallas, Tex.). Roofing membranes of the present invention, even after exposure to environmental conditions, exhibit minimal or no loss in reflectivity. For example, roofing membranes of the present invention after lengthy exposure to environmental conditions (such as for example, mildew, humidity and temperature fluxuations) generally exhibit reflectivities comparable to roofing membranes that have not been exposed to such conditions.

Roofing membranes of the present invention may be formulated using any method known to one of skill in the art for making roofing membranes. Generally, roofing membranes of the present invention may be constructed by placing the thermoplastic material into a hopper. The thermoplastic material is then heated to a sufficient temperature. While the thermoplastic material is being heated, the microbial inhibitor may be added to the thermoplastic material along with any other desired additive such as for example, a UV stabilizer, depending on the desired end product. The thermoplastic material and other components may be combined with one or more layers of scrim material. Generally, this process may be conducted in a calendaring apparatus or similar device to combine various materials. If a calendaring device is used, a scrim material is placed into the calendaring apparatus and combined with the thermoplastic material.

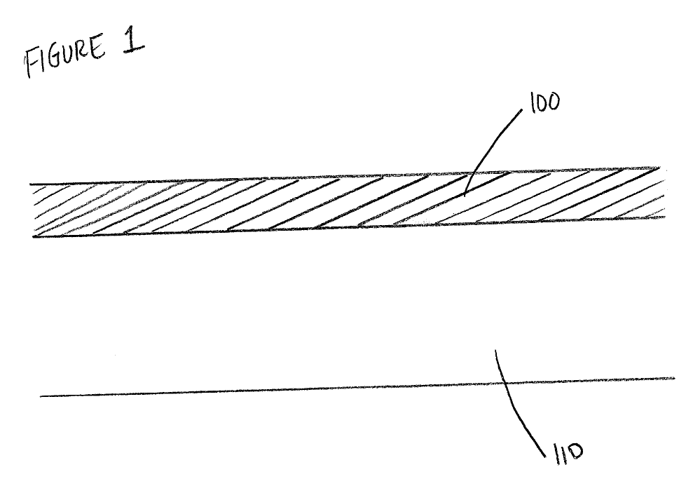

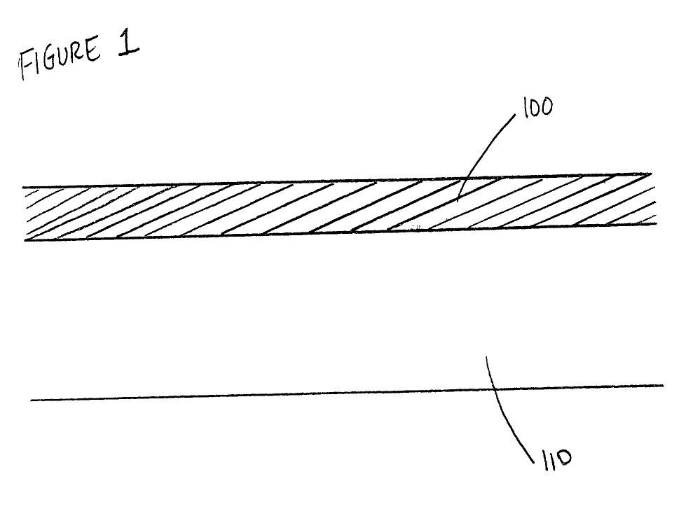

The calendaring device then laminates the layers together to form a roofing membrane. Any calendaring device may be used. Generally, the calendaring device has two or more rollers that press, with or without heating, the materials placed into the device. The resulting membrane may be a single ply membrane or laminate. Roofing membranes of the present invention also may be made by producing each thermoplastic layer separately, for example by using a Banbury, and then laminating the thermoplastic material to the scrim material using a calendaring operation. The lamination of the scrim material with the thermoplastic layer or layers may be done simultaneously, or as separate operations. As depicted in FIG. 1, membranes of the present invention may be formed by laminating or coextruding a layer of thermoplastic material that contains a microbial inhibitor (100) to one or more additional layers of material (110).

Any type of extruder known in the art may be used to feed the thermoplastic material though the calendaring device. Generally, the extruder (or extruders in multiple systems) feed the molten resin through sheet dies and then to rollers that are typically chilled. A scrim layer may be fed between multiple layers of thermoplastic material and the entire membrane is cooled and then may be wound into a roll.

The following examples are presented to further illustrate the present invention and are not to be construed as unduly limiting the scope of the present invention.

### EXAMPLE 1

The following materials were used in preparing and testing the roofing membranes according to one embodiment of the present invention. Soft Cattaloy KS 050® (obtained from Basell) was combined with zinc oxide, polyisobutylene, and titanium dioxide as well as an antioxidant, UV stabilizer, and flame retardant. The components (as shown in Table 1) were mixed using a compounding extruder. The resin formulation was then heated and extruded into a sheet approximately 1 mm (0.04 inches) thick using a 1.5-inch extruder with a 38:1 L/D. The L/D ratio is the ratio of the length of the barrel of the extruder to the diameter of the extruder screw. The sheets were placed into a calendaring apparatus to form roofing membranes of the present invention. Table 1 shows three roofing membrane samples of the present invention labeled A, B and C.

TABLE 1
COMPONENTS OF ROOFING MEMBRANE SAMPLES
A-C OF THE PRESENT INVENTION

| | Roofing Membrane | | |
|---|---|---|---|
| Component | A | B | C |
| Magnesium Hydroxide | 23 | 23 | 23 |
| Soft Catalloy ® | 51.3 | 48.3 | 45.3 |
| Zinc Oxide | 20.0 | 20.0 | 20.0 |
| Chimmasorb 944 ™ (UV | 0.5 | 0.5 | 0.5 |
| Stabilizer) | | | |
| Westin 626 ™ | 0.2 | 0.2 | 0.2 |
| (Antioxidant) | | | |
| Polyisobutylene | 3 | 3 | 3 |
| Titanium dioxide | 2 | 2 | 2 |
| Zinc Stearate | — | 5 | 5 |
| Tinuvin 770 ™ (UV | — | — | 1 |
| Stabilizer) | | | |

### EXAMPLE 2

The samples prepared in Example 1 were tested. Samples A-C were placed on the roof of a building and exposed to varying environmental conditions over an expanded period of time (approximately 8 years). Periodically, the samples were examined for retention of physical properties, cracking and color. Table 2 shows the results. Samples A-C remained very white in color with no presence of microbial growth. Each of the inventive examples maintained their physical properties, remained free of microbial growth and maintained their reflectivity, even after an extended period of time.

TABLE 2
REFLECTIVITY OF ROOFING MEMBRANE SAMPLES
A-C OF THE PRESENT INVENTION

| | Roofing Membrane | | |
|---|---|---|---|
| | A | B | C |
| Reflectivity | 76.3% | 79.4% | 77.8% |

By comparison, TPO membranes without microbial inhibitors generally show a 30 to 50 percent drop in reflectivity after aging outdoors. For example, a study conducted by Oakridge National Laboratories for the Single Ply Roofing Institute revealed that most white roofing membranes showed a 30 to 50 percent drop in reflectivity after three years of outdoor exposure.

Table 3 compares the reflectivity of roofing membrane samples A-C of the present invention with various other materials. As shown in Table 3, roofing membranes of the present invention exposed to the environment over a period of time (approximately 8 years), exhibited minimal or no loss in reflectivity. This is significant because roofing membranes of the present invention, even after lengthy exposure to the outdoors, exhibited reflectivity ratings comparable to roofing membranes that were not exposed to such conditions.

TABLE 3
COMPARISON OF REFLECTIVITIES

| Roofing Membrane | Reflectivity |
|---|---|
| A (exposed) - 20% ZnO | 76.3% |
| B (exposed) - 20% ZnO | 79.4% |
| C (exposed) - 20% ZnO | 77.8% |
| Commercial TPO Sheet | 78-83% |
| (unexposed) | |
| UVTEC (unexposed) - 20% ZnO | 78.3% |
| UVTEC (unexposed) - 3% ZnO | 79.4% |
| (8 years old) | |
| UVTEC (exposed) - 3% ZnO | 57.2% |
| (8 years old) | |

What is claimed is:

1. A roofing membrane comprising:
at least one thermoplastic layer comprising at least one thermoplastic material and at least one microbial inhibitor integrated into the thermoplastic.

2. The roofing membrane of claim 1, further comprising at least one scrim layer, wherein at least a portion of the scrim layer is in contact with the thermoplastic layer.

3. The roofing membrane of claim 2, wherein the scrim layer comprises a polyester material.

4. The roofing membrane of claim 2, wherein the scrim layer comprises a fiberglass material

5. The roofing membrane of claim 1, wherein the thermoplastic material is selected from the group consisting of thermoplastic olefinic elastomer (TPO) and polyvinyl chloride (PVC).

6. The roofing membrane of claim 1, wherein the thermoplastic material is thermoplastic olefinic elastomer (TPO).

7. The roofing membrane of claim 1, wherein the thermoplastic material is polyvinyl chloride (PVC).

8. The roofing membrane of claim 1, wherein the microbial inhibitor is selected from the group consisting of metal oxides.

9. The roofing membrane of claim 1, wherein the microbial inhibitor is zinc oxide.

10. The roofing membrane of claim 1, wherein the microbial inhibitor is present in an amount effective to inhibit the growth of microorganisms on the roofing membrane.

11. The roofing membrane of claim 1, wherein the microbial inhibitor is present in an amount in the range of from greater than about 3 to about 90 weight percent.

12. The roofing membrane of claim 1, wherein the microbial inhibitor is present in an amount of about 20 weight percent.

13. The roofing membrane of claim 1, wherein the thermoplastic layer further comprises an additive.

14. The roofing membrane of claim 13, wherein the additive comprises UV stabilizers.

15. The roofing membrane of claim 13, wherein the additive comprises a pigment.

16. The roofing membrane of claim 1, wherein the membrane, after exposure to environmental conditions has minimal or no loss of reflectivity.

17. A method of making a roofing membrane comprising the step of:
contacting at least one thermoplastic layer and at least one scrim layer, wherein the thermoplastic layer contains at least one thermoplastic material and at least one microbial inhibitor, and wherein at least a portion of the scrim layer is in contact with the thermoplastic layer.

18. The method of claim 17, wherein the thermoplastic material is selected from the group consisting of thermoplastic olefinic elastomer (TPO), polyvinylchloride (PVC), and the like and mixtures thereof.

19. The method of claim 17, wherein the thermoplastic material is thermoplastic olefinic elastomer (TPO).

20. The method of claim 17, wherein the thermoplastic material is polyvinyl chloride (PVC).

21. The method of claim 17, wherein the microbial inhibitor is selected from the group consisting of metal oxides.

22. The method of claim 17, wherein the microbial inhibitor is zinc oxide.

23. The method of claim 17, wherein the microbial inhibitor is present in an amount effective to inhibit the growth of microorganisms on the roofing membrane.

24. The method of claim 17, wherein the microbial inhibitor is present in an amount in the range of from greater than about 3 to about 90 weight percent.

25. The method of claim 17, wherein the microbial inhibitor is present in an amount of about 20 weight percent.

26. The method of claim 17, wherein the thermoplastic layer further comprises an additive.

27. The method of claim 26, wherein the additive comprises a UV stabilizer.

28. The method of claim 26, wherein the additive comprises a pigment.

29. The method of claim 17, wherein the membrane, after exposure to environmental conditions has minimal/or no loss of reflectivity.

30. The method of claim 17, wherein the scrim layer comprises a polyester material.

31. The method of claim 17, wherein the scrim layer comprises a fiberglass material.

32. A method of making a roofing membrane comprising the step of contacting at least one thermoplastic layer and at least one scrim layer, wherein the thermoplastic layer contains thermoplastic olefinic elastomer and zinc oxide, and wherein at least a portion of the scrim layer is in contact with the thermoplastic layer.

33. A composition comprising:
at least one thermoplastic layer comprising at least one thermoplastic material and at least one microbial inhibitor integrated into the thermoplastic.
